(19) United States
(12) Patent Application Publication
(10) Pub. No.: US 2013/0018587 A1
(43) Pub. Date: Jan. 17, 2013

(54) HYDROCARBON DETECTION SYSTEM AND METHOD

(71) Applicants: Robert J. Clark, Andrews, TX (US); Daniel P. Smith, Odessa, TX (US)

(72) Inventors: Robert J. Clark, Andrews, TX (US); Daniel P. Smith, Odessa, TX (US)

(73) Assignee: Hydrocarbon Imaging Services, Inc., Andrews, TX (US)

(21) Appl. No.: 13/467,922

(22) Filed: May 9, 2012

Related U.S. Application Data
(60) Provisional application No. 61/518,615, filed on May 9, 2011.

(51) Int. Cl. G01V 5/02; G06F 19/00

(52) U.S. Cl. 702/8; 250/253

(57) ABSTRACT

A system and method for detecting hydrocarbon deposits includes a sensor that can measure radiation emanating from an earth surface within an area of interest and separate the measured radiation into component signals, each having a particular characteristic associated with the presence of hydrocarbon deposits. The system also includes a processor that can receive the component signals from the sensor, determine a difference between the component signals and a baseline radiation for the area of interest, and display data showing a likelihood of the presence of hydrocarbon deposits in locations within the area of interest based on the difference between the measured radiation and the baseline radiation. The processor may also generate maps of the area of interest.

### CROSS-REFERENCE TO RELATED APPLICATIONS

This application claims benefit of U.S. provisional patent application Ser. No. 61/518,615, filed May 9, 2011, which is incorporated herein by reference in its entirety.

### FIELD OF THE INVENTION

The instant invention relates to detection of hydrocarbon deposits in the earth. More particularly, the invention relates to systems and methods for locating oil, natural gas, or other fossil deposits through the detection, logging and charting of both the beta and gamma rays emitted from the earth basement.

### BACKGROUND

Seismic detection of oil and gas can be costly, time consuming, and inaccurate. Additionally, in order to provide accurate results, seismic graphing often requires that the seismic survey be expanded into areas surrounding the immediate area of interest. This can be very expensive for the party purchasing or contracting the data, and in some cases the data may not be available for the party in a commercially viable time frame.

Naturally occurring radiation emanating from the earth, such as gamma or beta rays, can provide insight into the location of hydrocarbon deposits under the surface of the earth. This is because hydrocarbon deposits may tend to block radiation. Therefore, in locations where hydrocarbon is present, less radiation may emanate. However, such techniques for locating hydrocarbon deposits have been historically inaccurate. Additionally, since water tends to absorb the radiation, such techniques have not been used in underwater environments.

### BRIEF DESCRIPTION OF THE DRAWINGS

All figures depicting hydrocarbon imaging results are for demonstration purposes only. No quantifiable hydrocarbon information can be garnered from the maps and information shown throughout the figures.

FIG. 1 is a block diagram of a sensor for receiving radiation, in accordance with an embodiment of the invention.

FIGS. 2A and 2B illustrate systems for over-land traversal an area of interest to record radiation measurements, in accordance with an embodiment of the invention.

FIG. 2C shows a map of an area of interest, in accordance with an embodiment of the invention.

FIG. 3A illustrates a system for air-traversal of an area of interest to record radiation measurements, in accordance with an embodiment of the invention.

FIG. 3B shows a map of an area of interest, in accordance with an embodiment of the invention.

FIG. 4A illustrates a system for subaqueous-traversal of an area of interest to record radiation measurements, in accordance with an embodiment of the invention.

FIG. 4B illustrates a cable head assembly, in accordance with an embodiment of the invention.

FIG. 5 illustrates a system for subaqueous-traversal of an area of interest to record radiation measurements, in accordance with an embodiment of the invention.

FIG. 6 illustrates a sensor system for subaqueous use, in accordance with an embodiment of the invention.

FIGS. 7A-7B illustrate a sensor system for mounting on a seagoing vessel, in accordance with an embodiment of the invention.

FIGS. 8A and 8B illustrate a system for subaqueous-traversal of an area of interest to record radiation measurements, in accordance with an embodiment of the invention.

FIG. 9 illustrates a system for determining the position of an underwater sensor, in accordance with an embodiment of the invention.

FIG. 10 illustrates a system for determining the position of an underwater sensor, in accordance with an embodiment of the invention.

FIG. 11 illustrates a system for determining the position of an underwater sensor, in accordance with an embodiment of the invention.

FIG. 12A illustrates a map and traversal path of an area of interest, in accordance with an embodiment of the invention.

FIG. 12B illustrates a contour map showing radiation measurements, in accordance with an embodiment of the invention.

FIG. 13A-13H show maps of an area of interest, in accordance with an embodiment of the invention.

FIG. 14A-14C show maps of an area of interest, including gamma ray logs, in accordance with embodiments of the invention.

FIG. 15 shows a map of an area of interest, in accordance with an embodiment of the invention.

FIG. 16 shows a map of an area of interest, in accordance with an embodiment of the invention.

FIG. 17 shows a map of an area of interest, in accordance with an embodiment of the invention.

FIG. 18 shows a system for detecting hydrocarbon, in accordance with an embodiment of the invention.

### DETAILED DESCRIPTION

### Overview

The present invention relates to the detection of hydrocarbon deposits such as oil and gas beneath the surface of the earth Embodiments of the methods and systems for detecting hydrocarbon deposits can be used over or on land, from the air, or underwater.

In an embodiment, in order to detect hydrocarbon deposits under the surface of the earth, a sensor may be used to detect radiation emanating from the earth. The radiation may result from naturally occurring isotopes, such as uranium, potassium, thorium, and the like, under the earth substrata of the earth. The sensor may be moved along the surface of the earth, on land or underwater, so that the radiation can be detected as the sensor traverses across a surface area of interest.

As the sensor traverses the area of interest, the level of radiation picked up by the sensor will vary. For example, hydrocarbon deposits such as oil, gas, or other fossil fuels under the earth's surface can block the radiation so as to reduce the amount of radiation received in certain areas. Accordingly, in areas where hydrocarbon deposits are present, the sensor may pick up less radiation than it would in areas where there are no hydrocarbon deposits.

The sensor may be part of a system that includes a positioning system, such as a GPS or other positioning system, so that the location of the sensor can be associated with each radiation measurement from the sensor. This allows the radiation measurements to be used to create two or three dimensional maps of the area of interest based upon the radiation readings taken over the surface of the area. The maps can be used to determine locations, within the area of interest, where hydrocarbon deposits may be present, and where commercial drilling may be viable.

In order to increase the accuracy of the maps, the system can incorporate other information into the maps. This information can include historical information about hydrocarbon wells in the area, geographical information about the area of interest, locations of roads or other man-made structures in the area, and other information which will be described below.

### Sensor

In an embodiment, a sensor used to detect radiation emanating from the earth may include a housing, at least one scintillator within the housing that can convert radiation into light pulses, and a circuit that can convert the light pulses into electrical signals and data for display and/or mapping.

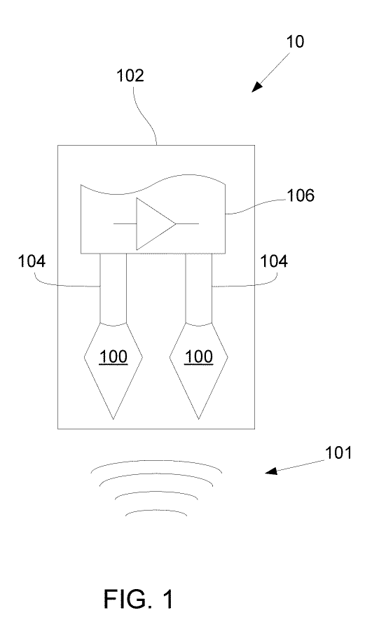

FIG. 1 shows a diagram of a sensor 10 in accordance with an embodiment of the invention. As shown, scintillators 100 for detecting radiation 101 from the earth may be positioned within a housing 102 or sensor 10. The scintillators 100 may be connected to one or more photomultiplier tubes 104 that can translate light pulses, converted from detected radiation moving through the scintillators 100, into electrical signals. A circuit 106, coupled to the photomultiplier tubes 104, can then process the electrical signals for subsequent use in generating a display, such as a map. Although multiple scintillators 100 are shown, the sensor 10 may have a single scintillator 100 in an embodiment.

In an embodiment, the scintillators 100 in the sensor 10 may include crystals of Lutetium Yttrium Orthosilicate (LYSO), Bismuth Germinate (BGO), Thallium doped Sodium Iodide (Nal), Cerium doped Lanthanum Bromide (LaBr₃), or similar polycrystalline materials.

When radiation, such as gamma radiation, hits the scintillators 100, it may cause a photon or light pulse to occur within a crystalline structure of the scintillator. The intensity of the light pulse may be directly proportional to the strength of the radiation received. Once the radiation is converted into a light pulse, circuit 106 can receive the light pulse, and produce a corresponding electrical signal. Since the magnitude of the electrical signal may be directly proportional to the intensity of the light pulse, if the strength of the radiation in an area is high, the corresponding magnitude of the electrical signal may also be high.

In another embodiment, scintillators 100 may include any other type of crystal or material that can scintillate and convert radiation into light pulses. In other embodiments, other non-scintillating methods of detecting radiation can be employed, so long as the detected radiation can be captured and subsequently recorded as data.

The radiation from the earth may come from different sources. In order to differentiate the radiation from different sources, circuit 106 may include at least one programmable controller (not shown) to generate the electrical signal. The controller may be, in an embodiment, a digital signal processing (DSP) chip or other processor that can manipulate the electrical signal by, for example, separating the electrical signal into component signals each representing radiation received from a particular isotope or radiation source. In an embodiment, the circuit 106 may separate the electrical signal into component signals that represent the radiation received from thorium, uranium, and/or potassium. The separation may be based upon the voltage level of the electrical signals received from the scintillators 100. The circuit 106 may also provide a measurement of the total amount of radiation received.

While many naturally occurring elements have radioactive isotopes, potassium (40K), and the uranium (238U) and thorium (232Th) decay series, may have radioisotopes that produce relatively strong gamma rays for use in gamma ray spectrometry. To this end, the DSP can separate the radiation signal into component signals based upon the individual microvoltage levels of the radiation received. For example, voltage levels between about 1.2 MeV and about 1.6 MeV may indicate the source of the radiation is potassium; voltage levels between about 1.6 MeV to about 2 MeV may indicate the source of the radiation is uranium, and voltage levels between about 2 MeV and 3 MeV may indicate the source of the radiation is thorium. The DSP can also produce a total gamma ray count, which may correspond to voltage levels between about 0.4 MeV and about 3 MeV. Separating the radiation into component signals representative of particular isotopes can aid in developing displays, such as maps, that can be used to visualize the location of hydrocarbon deposits, as will be discussed below.

The circuit 106 may also count the number or frequency of radiation pulses received in an area along which detection is being carried out to determine the number of radiation pulses received by the scintillators 100 and/or the intensity of the radiation emanating from the earth. As noted, hydrocarbons under the immediate top surface of the earth can block radiation emanating from the earth. Accordingly, in areas where hydrocarbon deposits are present, the sensor 10 may receive fewer radiation pulses, or radiation pulses at a lower frequency, than in areas where no hydrocarbon is present. The radiation counts can subsequently be used to determine the likelihood of hydrocarbon deposits in the area of interest, which will be discussed below in greater detail.

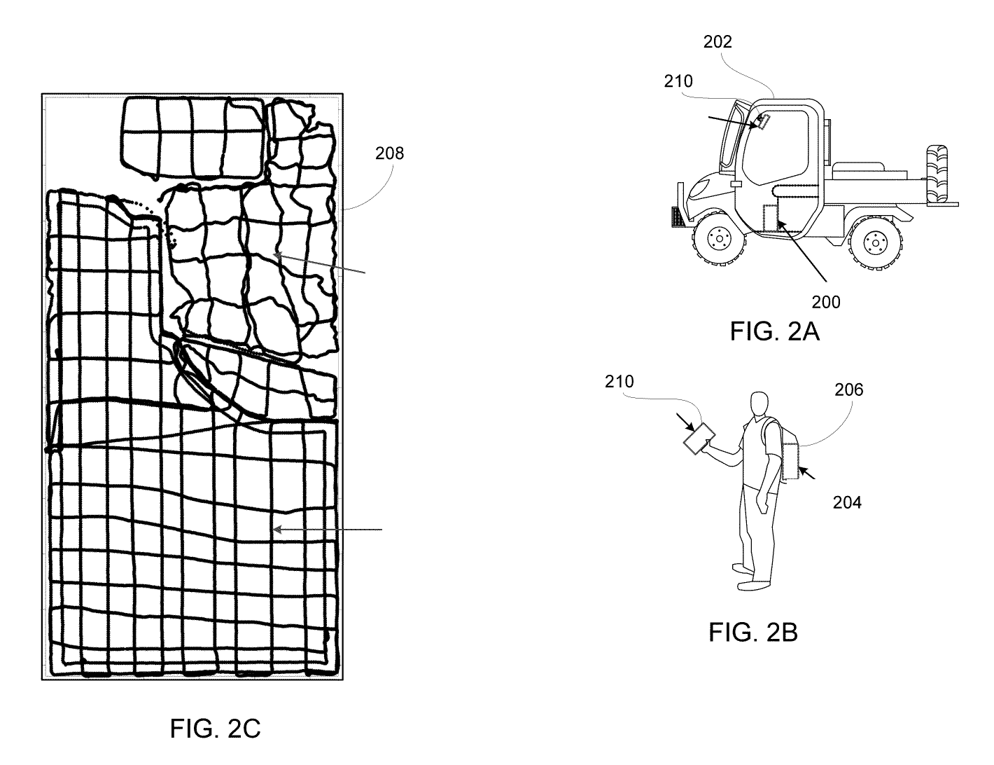

In one embodiment, the sensor 10 can be situated within a housing for protection against damage. Various housings 102 may allow the sensor 10 to be used at sea, on land, on or near the ocean floor, on or near dry land masses, on or near marsh bottoms, on or near inland sea bottoms, in areas of thick forestation and jungle environments, etc. For example, as shown in FIG. 2A, a housing 200, within which sensor 10 is situated, may be mounted to a vehicle 202. In another embodiment, as shown in FIG. 2B, a housing 204 may fit within a backpack 206 or saddlebag. These embodiments may allow the sensor 10 to be carried by a vehicle, person, or animal so that it can traverse an area of land that is of interest to detect radiation. As shown, the sensor 10 may be coupled, through a wireless or wired communication link, to a laptop or other computing device 210 that can receive and process the radiation data.

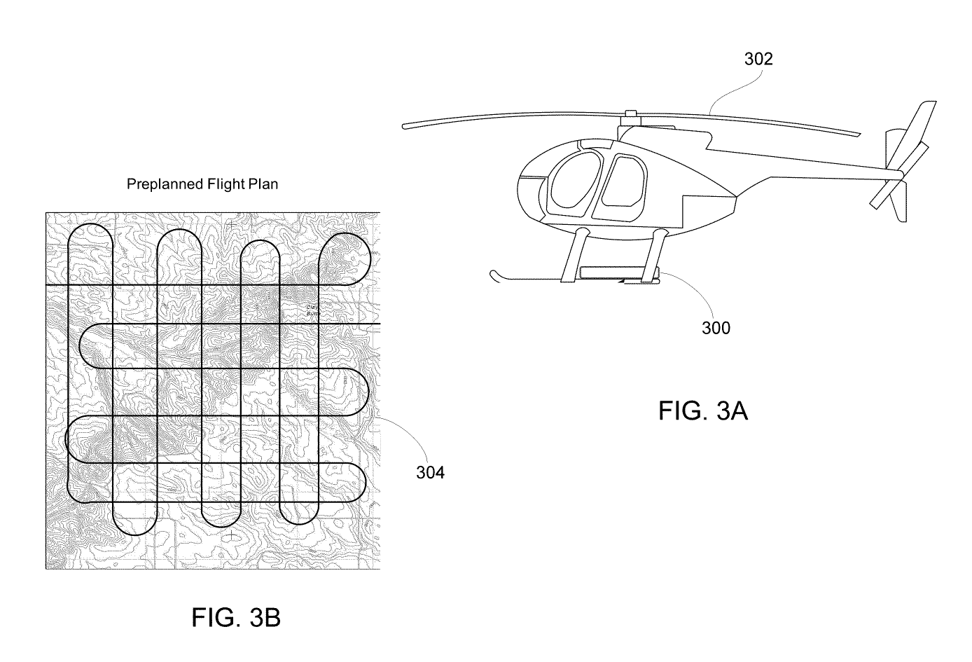

A housing 300 can also be mounted onto an aircraft 302 such as a helicopter or plane, as shown in FIG. 3A. This may allow the sensor 10 to be moved over the surface of an area of interest to detect radiation. Traversal charts 208 (FIG. 2C) and 304 (FIG. 3B) show sample traversal patterns that can be traveled by a vehicle, person or animal, or aircraft while carrying sensor 10.

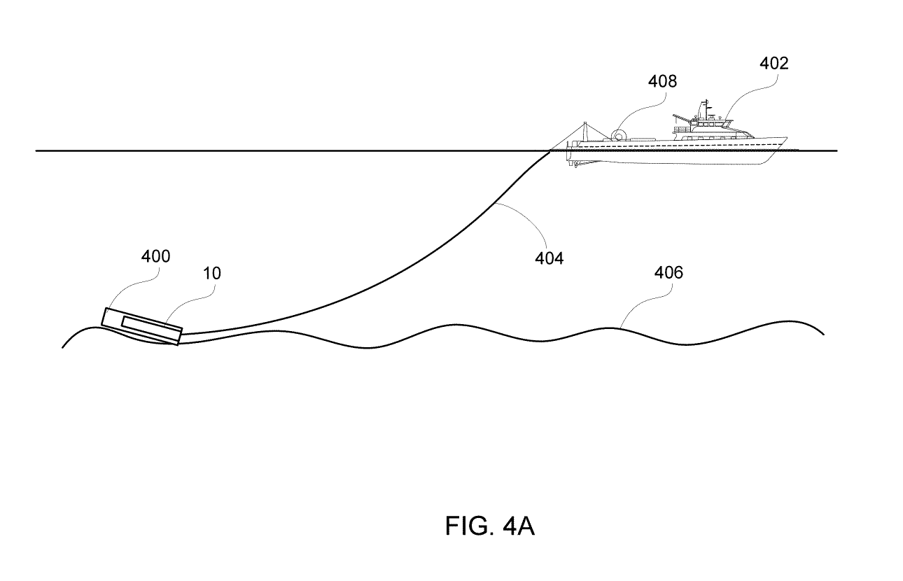

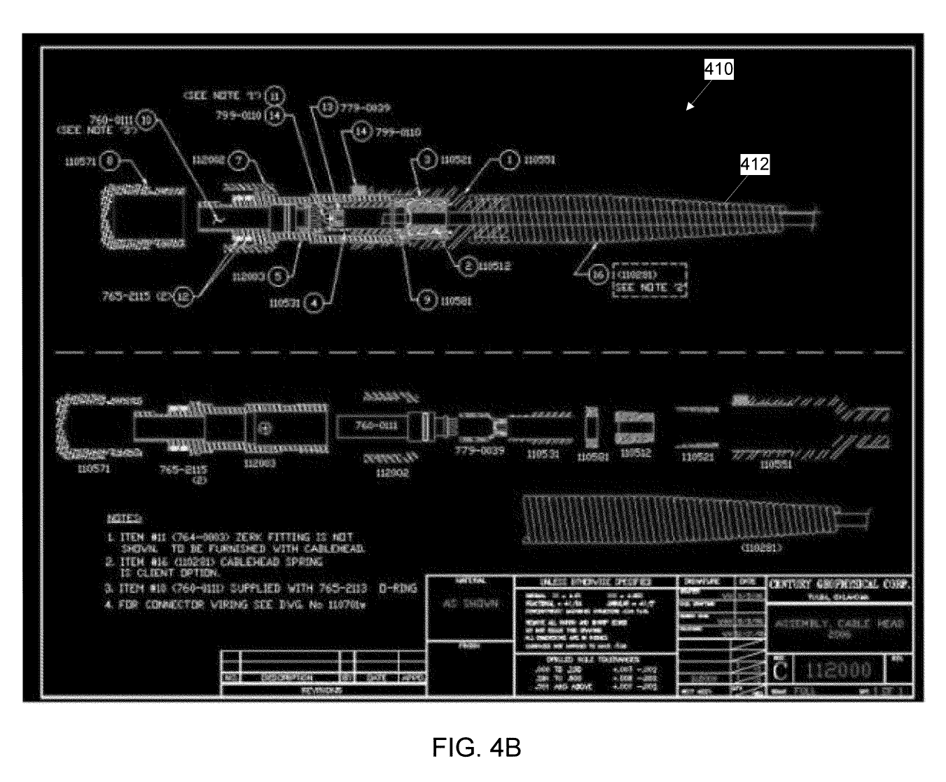

In another embodiment, a housing 400 may be designed to be used subaqueously, as shown in FIG. 4A, where housing 400 can be substantially fluid-tight so that the sensor 10 can traverse an underwater area to detect radiation. In such an embodiment, the sensor 10 may be tethered to a surface vessel, such as boat 402, by a cable 404. Cable 404 may include electrical wires or cables so that can provide power to the sensor 10 and allow the sensor 10 to communicate with computer equipment on boat 402. In an embodiment, the sensor 10 may be used at depths ranging from about 1 meter to about 3000 meters or greater.

The housing 400 may include a pipe, hose, or tube within which the scintillator 100 and associated electronics and connectors can be accommodated. In an embodiment, the housing 400 may be towed behind the vessel in a substantially horizontal position. This may allow the scintillator 100 to remain near or embedded into the underwater floor for accurate radiation readings. Should the sensor 10 rise off the floor, gamma ray and other radiation readings may become inaccurate due to the dispersion and absorption by the water. In an embodiment, the housing 400 may be fluid-tight so that the sensor 10 is not directly exposed to water.

The cable 404, in an embodiment, may be spooled onto spool 408 on the deck of the boat 402 and let out to a sufficient length so that the housing 400 can remain on or near the floor 406. Since radiation emanating from the earth may tend to dissipate or be absorbed by the water within a few feet of the underwater surface 406, maintaining the sensor 10 on or near the surface 406 may allow the sensor 10 to receive radiation readings in a water-based environment.

It should be appreciated that, if the underwater floor 406 is uneven or has obstacles, towing the sensor 10 behind a boat 402 may cause the sensor 10 to be roughly jostled and damaged, or detached and lost. In order to minimize damage, cable 404 and housing 400 may include features to protect the sensor 10 as it is towed. These features may include strain reliefs, shock absorbers, and the like. FIG. 4B shows an example of a subaqueous cable head assembly 410 with a strain relief that can act to minimize damage to a sensor 10 that is towed behind a boat. In an embodiment, the cable windings 412 within the cable head assembly 410 may act as a strain relief and provide enough connective force to keep the sensor 10 from becoming dislodged from the cable 404 and lost.

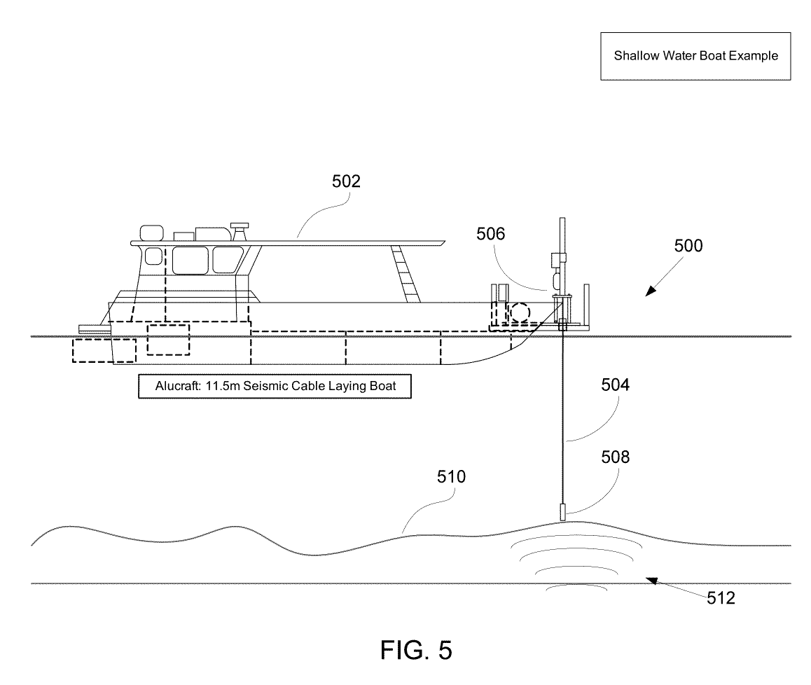

In another embodiment, the housing 400 may include of a vertical rod 504 or conduit that can move the sensor 10 up and down so that it can access the floor 406. As shown in FIG. 5, housing 500 may be mounted on a surface vessel 502. Housing 500 may include a vertical rod 504, which may be a solid, segmented, and/or hollow tube, for example. Rod 504 can be moved up and down by a piston drive 506, such as motor. Housing 500 may also include a distal end 508, within which the scintillators 100 may be positioned. As the piston drive 506 moves rod 504 up and down, the distal end 508 may penetrate the underwater floor 510 so that the scintillators 100 can obtain an accurate reading of radiation 512. In an embodiment, the piston drive 506 and distal end 508 may be used in depths of about 1 meter to about 200 meters or greater.

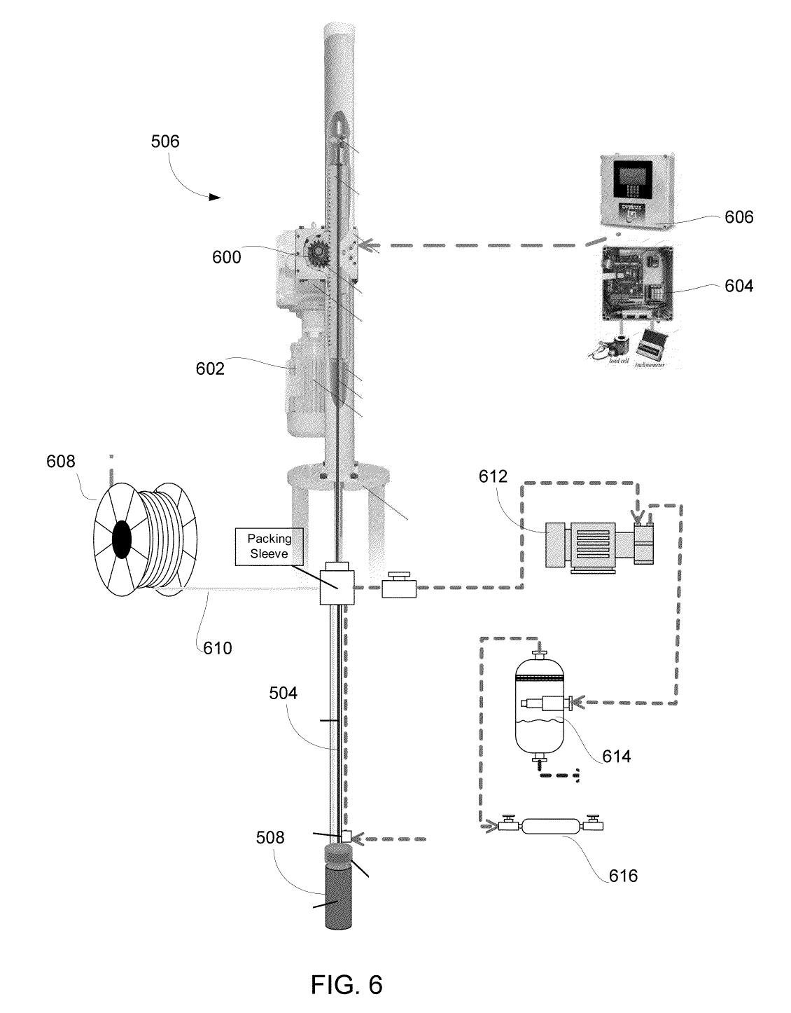

FIG. 6 shows another example of a piston drive 506 and tube 504. The piston drive 506 includes gears 600 which can be turned by an electric motor 602. A programmable drive controller 604 can control the speed, timing, and direction of the motor in order to control the up and down motion of probe end 508. In an embodiment, the controller 604 can cause the probe end 508 to repeatedly move up and down, at a specified or variable frequency, during traversal of the area of interest. The display panel 606 can display information about the probe, such as the frequency of the up and down motion, as well as provide emergency shut off controls.

In an embodiment, if the data cable 610 for communicating with the sensor 10 is outside of tube 504, a winch system 608 may be used to provide a data connection to the probe end 508. In this embodiment, winch system 608 may be used to let out or take in the data cable 610 as the probe end 508 is raised and lowered.

The piston drive 506 can also include mechanisms for sampling and testing water during traversal of the area of interest. For example, a liquid pump 612 may pump fluid from the underwater surface near the distal end 508, so that the fluid can be sampled on board a surface vessel such as boat 502. Also a gas-liquid separator 614 may be used to separate gas from the water in the event that gas samples are needed or desired. A fluid sampling system 616 may also be included, and may be used to collect the liquid or gas samples that have been pumped into the vessel. In an embodiment, the fluid sampling system 616 may store the samples in containers without exposing them to the atmosphere in order to reduce the risk of contamination.

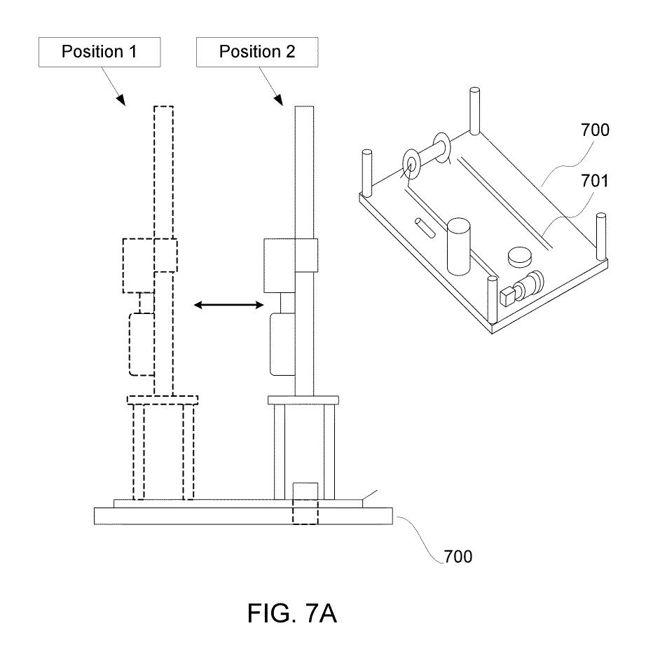

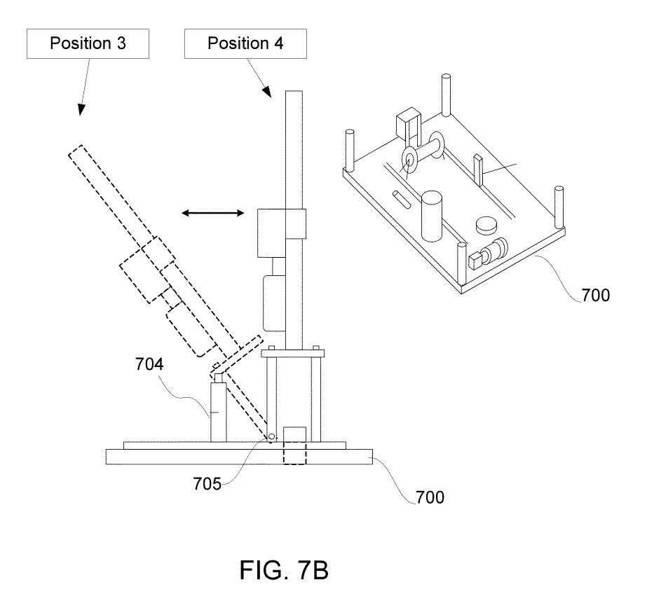

Piston drive 506, in an embodiment, may be mounted on a skid 700 that allows the boat to move while distal end 508 has accessed the underwater floor. The skid may be installed on the deck of the boat or vessel 502. As shown in FIG. 7A, skid 700 may allow piston drive 506 to travel back and forth on tracks 701 between Position 1 and Position 2 shown in FIG. 7A. In another embodiment, as shown in FIG. 7B, skid 700 may include a pivot 705 to allow piston drive 506 to pivot between position 3 and position 4 shown in FIG. 7B. Skid 700 may also include a brace 704 to prevent piston drive 506 from pivoting past a desired angle. These sliding and pivoting skids 700 provide mechanical play between the distal end 506 and the boat or vessel 502 that can allow the distal end 506 to remain penetrated within the underwater surface while the boat continues to move. If desired, the skid 700 may incorporate both tracks 701 and pivot 705 to allow for movement of the boat or vessel.

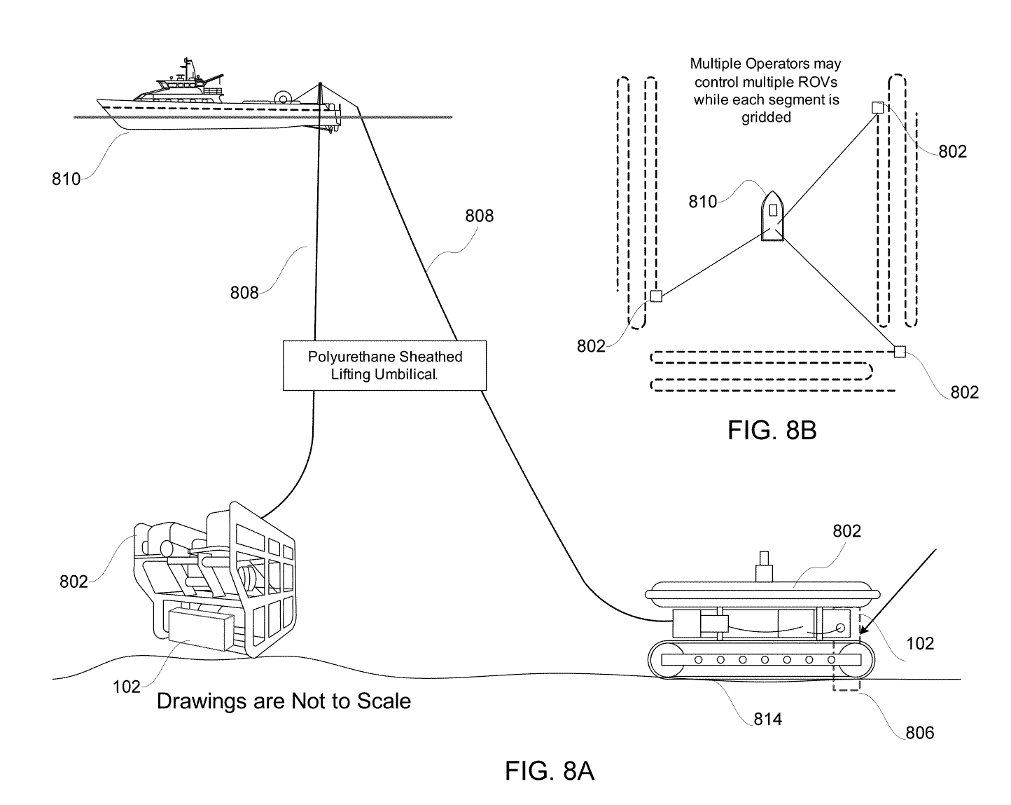

In another embodiment, as shown in FIG. 8A a sensor housing 102 may be mounted on an underwater rover, such as remotely-operated rover 802. The rover 802 may have thrusters (not shown), wheels (not shown), and/or tracks 814 for underwater propulstion. In an embodiment, the housing 102 can be mounted so that a section 806 of the sensor 10 penetrates silt, sediment, or other material on the underwater floor. The rovers may be in communication with a vessel 810 through cable 808. Cable 808 can provide power, controls for operating the rovers, and can also be used to lift or lower the rover into the water.

As shown in FIG. 8B, multiple rovers 802, each carrying a sensor 10, can be in communication with and controlled from a single vessel. This can allow the area of interest to be traversed in less time, if desired. As the rovers 802 traverse the area, the data received by the sensor 10 can be stored in a central computing system on board the vessel.

The housing 102 can incorporate, or include, various elements including, but not limited to: a structural platform and electronic configuration so as to integrate and connect power sources and facilitate data transfer; a composite connecting cable system or battery pack for power, data transfer, and towing; a shock absorbing encasement, i.e. hose, spayed coating, non-absorbing foam, plastic; additional geoscientific survey instruments, i.e. sonic tool, gamma ray neutron density, resistivity, magnetic, density, neutron, temperature, pressure, side sampler; a receiving controller of electronic data; a computer system for storing, organizing, and retrieving data; a modeling program for data input and interpretation; an integrated mapping program that incorporates all field data along with historical support information that includes well histories, seismic interpretations, well logs; etc.

Other instrumentation that can be used in conjunction with the sensor 10 or system includes, but is not limited to:

A Sonic Full Wave tool: A tool that sends an active sonar pulse that can be used to identify porosity and permeability matrices within the formation rock structure.

A Conductivity tool for measurement of electrical sensitivity to water saturations and content.

Gamma ray neutron density tools: Active inducement of man-made radioactive isotopes so as to measure hydrocarbon absorption characteristics of the rock of a given formation strata.

A gravitometer for measurement of a formation's gravitational response with baselines against known structures contrasted to the earth's polarities.

Magnetic locator tools for measurement of magnetic tendencies to the indigenous iron elements in a given formation.

Electro Magnetic tools for identifying a combination of electrical and magnetic properties in which known formations can be quantified for hydrocarbon content and possible formation depth.

A Magnetometer for measurement of magnetic tendencies to the indigenous iron elements in a given formation.

A General Neutron tool: A specially tuned device for tracing and identifying the more active and short lived neutron movement within a formation of the earth.

All-Density tools i.e. compensated density, near density, far density, high resolution density. These tools identify bulk concentration within the pore spaces of a given formation thus quantifying porosities and associated permeability of a formation.

An Acoustic Televiewer: A tool that mirrors the near faulting lenses of an earth formation from a vertical portal.

A Spontaneous Potential tool: This tool measures the electrical potential and thus quantifies the interplay between oil and water content within a reservoir.

Total Resistivity tools, i.e. fluid resistivity, guard resistivity, lateral resistivity, guard resistivity, micro resistivity, Single point resistance: These measurement tools may induce an electrical pulse and current into a given reservoir thus identifying oil and water content ratios.

Temperature tools: A a tool that measures temperature

A Vibration Indicator: A tool that measures vibration and contact with a side wall on a vertical plane or a horizontal plate.

A Fluid Sampler: A portal that opens a retention chamber for sampling water and/or solid samples.

A Petro Sonde tool: A tool that incites a strong sonic echo pulse so as to identify formation anomalies and their depth.

An Acoustic Transponder: A device that uses an acoustic signal in a directional or omni-directional pattern sending location to receiver.

These tools can be used to take additional measurements while the sensor 10 transverses across the area of interest and measures radiation. The measurements from these tools can be incorporated into maps showing the likelihood of the presence of hydrocarbon deposits below the surface of the earth.

Sensor Position

Since the radiation readings from the sensor 10 may be used for mapping radiation in the area of interest, it may be desirable to associate a position with each radiation reading. If the sensor 10 is mounted in an overland vehicle, a helicopter or plane, or carried by a person, a GPS (not shown) may be used to provide the position of each reading. However, if the sensor 10 is used underwater, other methods of positioning may be necessary.

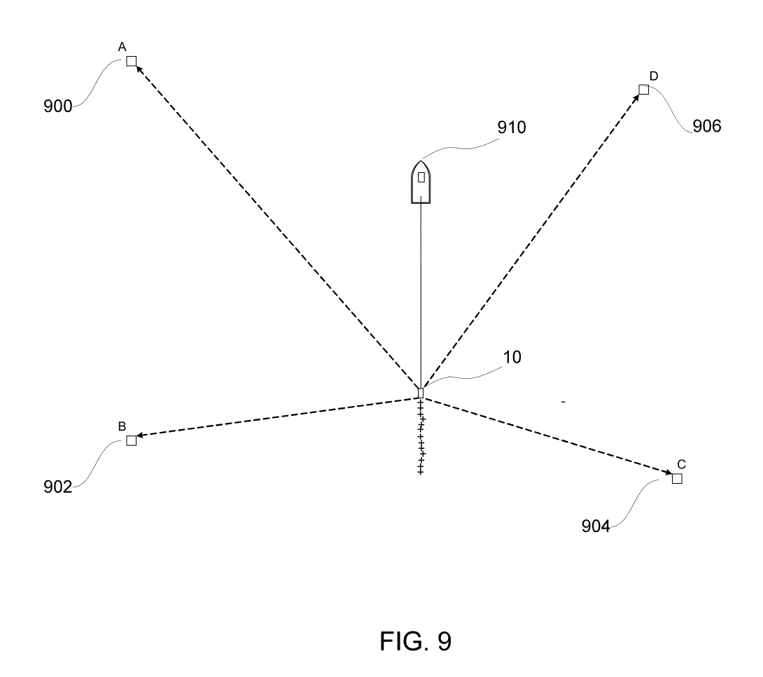

FIG. 9 shows a system for determining the position of an underwater sensor 10. Acoustic modems 900, 902, 904, and 906, in an embodiment, may be positioned in the water by buoys. Sensor 10 may include an acoustic transponder that can continuously or periodically send an acoustic signals to the modems 900, 902, 904, and 906. These modems can then relay the signal to the vessel 910, which can triangulate the position of the sensor 10 and associate that position with radiation readings received from sensor 10.

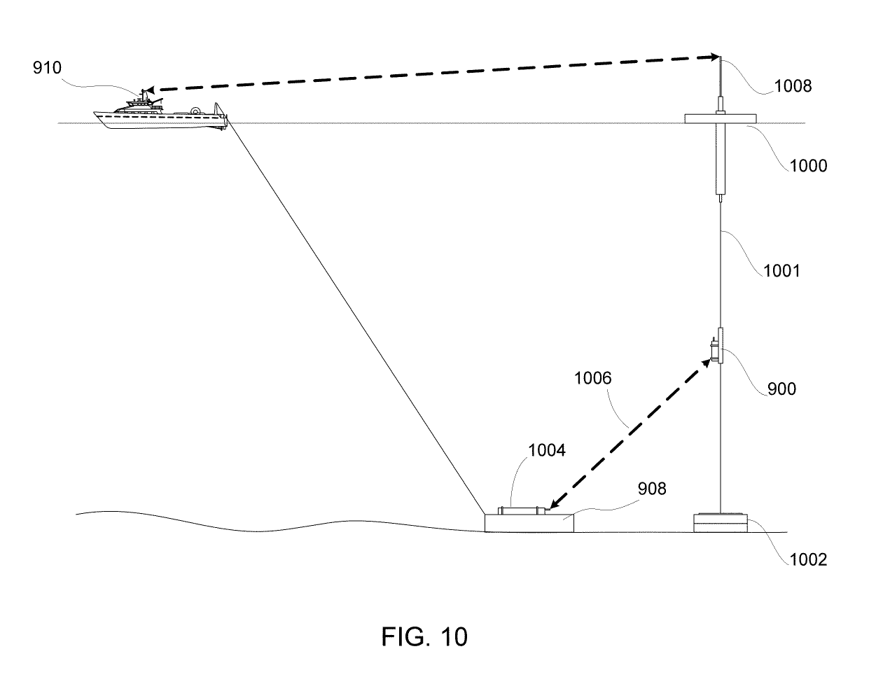

FIG. 10 shows an underwater view of an acoustic modem 900. Acoustic modem 900 may be attached to a cable 1001 that runs between buoy 1000 and weights 1002. Acoustic transponder 1004 can send an acoustic signal 1006 to acoustic modem 900. Acoustic modem 900 can then relay the signal, for instance through antenna 1008, to vessel 910. Once received, a computing system on board vessel 910 can triangulate the position of sensor 10.

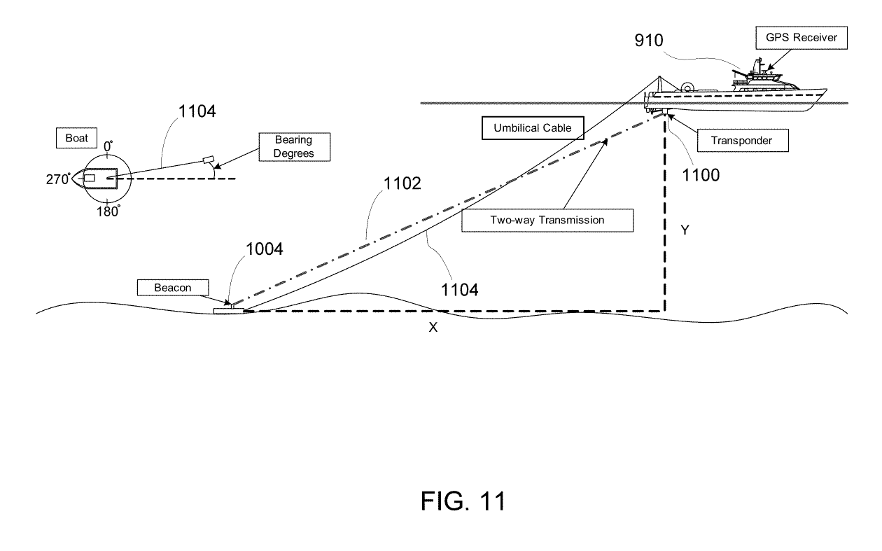

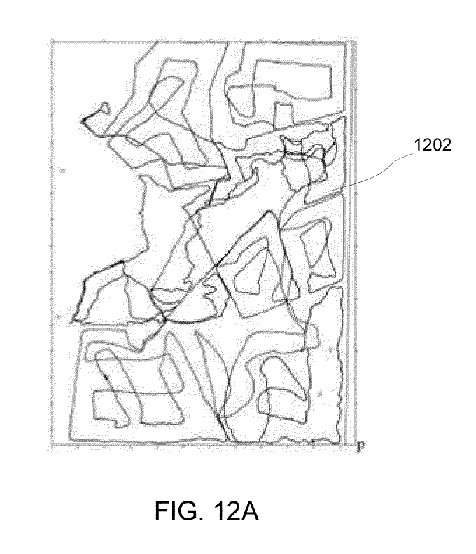

The position of the underwater sensor 10 can also be determined if the vessel 910 is equipped with a GPS, a depth finder, and an acoustic transponder, as shown in FIG. 11. In this embodiment, an acoustic transponder 1004 on the sensor 10 can send an acoustic signal to transponder 1100 on vessel 910. The length of hypotenuse 1102 can be calculated based on the time it takes the acoustic signal to be received. Since the depth finder (not shown) can determine the depth Y of the water, the distance X from the vessel can be calculated. The bearing or direction from the vessel to the sensor 10 can also be determined based on the angle of the tow cable 1104, or based on phase measurements of the acoustic signal. The GPS position of the vessel 910 can then be offset by the distance and bearing measurements in order to determine the position of the underwater sensor 10.

Mapping

The measured radiation can be used to determine, in an embodiment, whether hydrocarbon deposits are present under the earth's surface. The present invention can detect the presence of hydrocarbons in a variety of subsurface lithologies which include but not limited to: shales, sandstones, limestones, vugular limestone-dolomite, dolomite, salt domes, or any combination thereof. Once the radiation has been measured, the data can be combined with other information such as geographical anomalies and structures in the area of interest, historical oil well information, information about man-made structures such as roads and pipes, and the like. The system can then use the combination of data to generate maps that show a likelihood of hydrocarbon deposits in the area of interest.

Measuring Radiation

In order to measure the radiation, the sensor 10 of the present invention may take readings of radiation while it traverses an area of interest. During traversal, the radiation received by the sensor 10, and the position where the readings took place, can be recorded by a computing system. Table 1 below shows an example of data that can be recorded as the scanner traverses the area:

TABLE 1

| Sample | Serial | Channel 1 | Channel 2 | Channel 3 | Channel 4 | | | Speed | | |
|---|---|---|---|---|---|---|---|---|---|---|
| Number | Number | Total Counts | Uranium | Potassium | Thorium | Latitude | Longitude | (Knots) | Date (UTC) | Time (UTC) |
| 2225 | 276365 | 195.4 | 5.3 | 1 | 3.4 | 31.75373333 | −99.8586367 | 11.27 | 260811 | 220749 |
| 2224 | 276365 | 192.1 | 5.4 | 1.2 | 3 | 31.75373167 | −99.8585717 | 11.3 | 260811 | 220748 |
| 2226 | 276365 | 195.8 | 5.3 | 1.2 | 3.5 | 31.75372833 | −99.8586967 | 11.28 | 260811 | 220750 |
| 2223 | 276365 | 192.1 | 5.5 | 1.5 | 3 | 31.75372333 | −99.8585083 | 11.31 | 260811 | 220747 |
| 2227 | 276365 | 198.4 | 5 | 1.1 | 3 | 31.75372333 | −99.858755 | 11.26 | 260811 | 220751 |
| 2228 | 276365 | 201.1 | 5.2 | 1.1 | 2.6 | 31.75372167 | −99.85881 | 10.26 | 260811 | 220752 |
| 2229 | 276365 | 199.9 | 5.6 | 0.9 | 2.3 | 31.75371833 | −99.8588667 | 10.91 | 260811 | 220753 |
| 2222 | 276365 | 191.1 | 5.9 | 1.6 | 3 | 31.753715 | −99.858445 | 10.52 | 260811 | 220746 |
| 2230 | 276365 | 202.1 | 5.2 | 0.7 | 2.2 | 31.753715 | −99.85893 | 11.72 | 260811 | 220754 |
| 2231 | 276365 | 204.3 | 5.8 | 0.6 | 3 | 31.753715 | −99.858995 | 11.76 | 260811 | 220755 |

As described above, sensor 10 can separate radiation into component signals representative of radiation received from different isotopes. In the table above, each row represents a radiation sample taken by the sensor 10. The column labeled “Channel 1” shows the total gamma ray count received by the scanner. The column labeled “Channel 2” shows the gamma ray count attributable to Uranium, the column labeled “Channel 3” shows the gamma ray count attributable to Potassium, and the column labeled “Channel 4” shows the gamma ray count attributable to Thorium. The columns labeled longitude and latitude provide positional information for each sample. The table also includes a sample number column that shows the number of samples, a unit serial number that shows a serial number of the scanner, and date and time columns that show the date and time each sample was taken. Additional information can also be recorded with each sample, as desired.

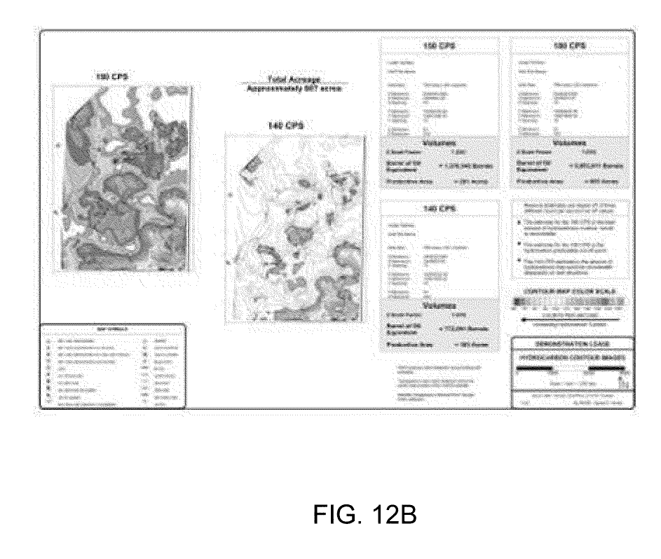

Data, such as those shown in Table 1, can be collected while the sensor 10 traverses the area of interest. In an embodiment, the sensor 10 can be moved in a grid pattern across the surface of the area of interest so that data can be extrapolated from most or all of the surface area. For example, the black line in FIG. 12 shows a traversal path 1202 along the surface of an area of interest. As the sensor 10 travels along the path, radiation data, such as the data shown in Table 1, can be recorded.

When the area of interest is traversed, the traversal path 1202 may not cover the entire surface of the area of interest. In other words, because it may be difficult or time consuming to take measurements from the entire surface if the area, there may be spaces or holes between the paths 1202 where no radiation measurement is taken. In other areas, it may be difficult to traverse the area due to terrain. This can be seen by the white areas in FIG. 12.

In order to provide more accurate information about the areas where no radiation measurement has been taken, the system may extrapolate the readings taken along traversal path 1202 to cover adjacent areas where no readings were taken. For example, a computer system executing a software program can perform an extrapolation routine, such as a natural neighbor calculation for example, on the recorded radiation data in order to extrapolate the radiation measurements to cover the entire area of interest.

One form of the natural neighbor calculation is:

G(x,y)=Σω₁f(xᵢ,yᵢ)

Where G(x,y) is the estimate at location (x,y) within the area of interest, ωᵢ is a weighting factor, and f(xᵢ,yᵢ) are the known data (i.e. the recorded radiation) at location (xᵢ,yᵢ). These calculations may use “irregularly spaced” XYZ data and produce or estimate a regularly spaced, rectangular array of radiation values. Since the traversal path 1202 may not follow a particular pattern, the recorded data may have many holes where the data is missing. Extrapolation calculations such as the natural neighbor can be used to fill in these holes by interpolating radiation values at those locations where recorded radiation data was not taken. The spacing of the regularly spaced grid is set based on the size of the area of interest.

Once the data has been recorded, the system can calculate the likelihood that hydrocarbon deposits exist under the surface of the area. In an embodiment, Lambert's Law may be used during the calculation. Lambert's Law is defined as follows:

I=I₀e^{-xm}

Where I is the incident radiation, Iₒ is the emerging (or measured) radiation, m is the absorption coefficient of the matter through which the radiation traveled, and x is the thickness of the matter. Using Lambert's Law one can measure and estimate the transmissity of the individual nuclear elements through known or assumed strata within the area of interest: i.e. sandstone, limestone, shale, brine water, natural gas, light hydrocarbons, heavy hydrocarbons. In formulating a baseline, the system can establish a zero hydrocarbon chimney, or baseline, whereby no absorption of the gamma rays is occurring within a given physical area and the readings from all adjacent areas are likewise identified and averaged to form the basis of all maps. Using Lambert's law, the baseline will take into account the depth of the earth basement complex and the material between the earth basement complex and the surface of the area of interest.

A baseline reading of 180 counts per second or greater, for example, may signify that no commercially viable hydrocarbons are present. Furthermore, since hydrocarbon deposits, oil, gas, and paraffin absorb or block radiation emanating from the earth, a lower count per second in a particular area may indicate the graduated absorption of gamma rays, and thus indicates stronger vertical migration of hydrocarbons as a result of the redox cell oxidation, reduction, and thermalization. In other words, a lower count per second may indicate the presence of hydrocarbons at a particular location. For example, a count of 160 per second in a particular area may indicate fewer hydrocarbons than a count of 130 per second. In an embodiment, a count of about 180 to about 160 may indicate an area of marginal production. A count of about 150 per second can indicate the presence of hydrocarbon deposits suitable for shallow or medium depth wells. A count of about 120 to about 140 counts per second may indicate the presence of hydrocarbon deposits suitable for deep wells. And a count of about 80 to 110 counts per second may indicate the presence of hydrocarbon deposits suitable for deeper wells.

All of these counts can be directly calculated to estimate the gross hydrocarbons present in a given area. The commercial viability can then be calculated depending upon the cost of acquisition of the property, the cost of drilling and completing the well, and the total available production of oil and gas. FIG. 12B shows an example of estimated quantity of oil and gas deposits within an area of interest, calculated by the system using Lambert's law.

The present inventions may estimate initial or remaining reserves based upon the reduction of radiation below 180 counts per second. The hydrocarbon response may be supported by nuclear physics that contrasts saltwater in reservoir rock against the absorption coefficient of hydrocarbons. Lambert's law of gamma ray migration may be used along with these absorption estimates on an average reservoir rock, i.e. sandstone, limestone, shale. The invention may establish data and/or hydrocarbon detection information for area of any lease which has 180 counts per second or lower. This may further establish the commercial or non-commercial quantity of hydrocarbons in the area depending upon drilling and/or development costs.

Reserve estimates may use the column volume of each grid segment, which may be generally 50×50 feet (area) multiplied by 180 counts per second. If the surface radiation is 100 counts per second, the 50×50 feet area may be 80 feet high. This volume multiplied by a proprietary coefficient may provide the barrels per acre reserves of oil or surface adjusted volume of gas per acre. The total number of grid segments can provide reserves for the area surveyed. The procedure accounts for variation over the area and stage of depletion in a producing field. It may be sensitive to depletion in a gas field and will show remaining reserves.

The overall property may be condensed or conflated into three primary areas of reserves that correlate into recovery factors. In some embodiments, estimates focus on 180 cps, 150 cps, and 140 cps and the corresponding acreage. The following assumptions may be incorporated in the system and software:

180+ counts per second: Non-commercial in all or most cases.

180-160 counts per second: Commercial for general low cost entry and Shallow, marginal production.

150 counts per second: Above Average reserves. Commercial for medium depth wells. Primary recoveries should be consistent with industry averages.

120-140 counts per second: Excellent reserve base. Commercial for deeper wells and longer sustained recoveries.

80-110 counts per second: Superior reserve base. Strong commercial likelihood for the deepest of wells. Strong Gas Oil Ratios.

Beta and gamma ray and radon gas reception at the surface of the area of interest may be coexistent, and may be inseparably associated with neutron activity throughout subsurface radiation. Since neutron activity and its consequent effects upon the beta and gamma ray activities are alternately activated, it follows that radiation received at the earth surface may allow for the slowing down of such activities. This can cause inaccurate radiation readings or calculations for geological structure contouring. This particularly applies to the use of spectrometer reception of gamma rays at high altitudes and at high speeds. Such gamma ray reception and monitoring may produce errors and so-called “halo” patterns bordering oil and gas reservoirs beneath the land based and subaqueous search surface. Accordingly, the system may be calibrated for slow speed, surface, close proximity to land surfaces, submersion to the sea floor, or any other environmental factor that may affect detection of beta and/or gamma rays and thereby reduce the halo effect.

Once the baseline has been calculated, the system may incorporate external interference factors into the calculation. Interference factors may refer to structures within the area that tend to block, absorb, or cause thermalization or decay of the neutron radiation emanating from the earth.

Interference factors such as the presence and type of stratum, rock, soil, and other material below the crust can affect the amount of radiation received at the surface. Therefore, the baseline calculations can be adjusted based on known stratum in the area of interest. For example, brines, or salt water, commonly present in sedimentary strata, can block radiation. These may reduce the recorded radiation reading by about 30 to about 45 counts per second, for example. Accordingly, if brine or saltwater is present, the system may adjust the baseline measurement by an appropriate amount to compensate. In like manner, the system can also adjust the baseline measurement to account for the presence and thickness of other materials, such as shale, limestone, granite, sand, or any other earth material in the area of interest. Other features that can by compensated for by adjusting the baseline measurement include subsurface domes, faults, reverse faults, anticline, synclines, water-oil contact, and water saturated reservoirs, man-made structures (e.g. roads, asphalt material, buildings, quarries, pipes, oil spills and seeps, etc.), recently plowed fields, vegetation, changing dunes and sand, naturally occurring Uranium, shale formations, radon gas, and weather conditions including dew point, barometric pressure, and recent rainfall, as well as other factors.

The presence of hydrogen 100 and carbon 15 in sedimentary strata may significantly block the neutron and attendant radiation in passing into such strata, and may reduce the baseline measurement by, for example, about 110 to about 120 counts per second. Therefore, once the baseline has been adjusted for known materials under the surface of the area of interest, drops in radiation readings on the order of about 110 to about 120 counts per second may indicate the presence of hydrocarbon deposits in the area.

Another factor that may be considered in calculating the baseline is the production of wells in the area. This information may be used to plot the exact well locations during the mapping process, as well as show possible reasons for the trends found during the imaging survey. Performing readings and mapping/interpreting the data in and around historical wells and areas of known hydrocarbon deposits may increase the accuracy of future readings and/or determinations of the presence of hydrocarbon.

A field technician may make baseline readings in and around known well locations, both active and non-active. These well readings may also be taken near and around open quarry pits and outcrops. Rapid and significant changes from low counts to high counts may be a clear indication of interference factors. Under normal conditions, with no interference factors present, there may be gradual change between readings by a factor of about 10 to 20 counts (i.e. radiation readings) per second. If readings increase or decrease at an accelerated rate in a particular area, or when moving from one area to another, an interference factor may be present, and may be recorded in the system for processing.

Furthermore, taking readings in and around existing wells may also provide valuable information about the well and/or hydrocarbon deposits in and around the well. For example, taking readings and performing a map/grid analysis in and around existing wells may help to determine whether the well is producing or dry, whether more hydrocarbon is present in the area, whether the well was drilled deeply enough, and/or whether the well is a candidate for re-entry, for example. Other determinations about the existing wells may also be made based on radiation readings and/or processing data on the maps and grids.

These readings can be used to adjust the baseline radiation for the area of interest since different regions may have different baseline radiation. For example, a first region may produce 150 counts per second of radiation from productive wells, while another region may produce 220 counts per second of radiation from productive wells. Using initial readings from productive and non-productive wells in the area, the system can adjust or normalize the area's baseline radiation measurement, so that readings that differ from the baseline can be used to more accurately determine whether hydrocarbon deposits are present

Map Generation

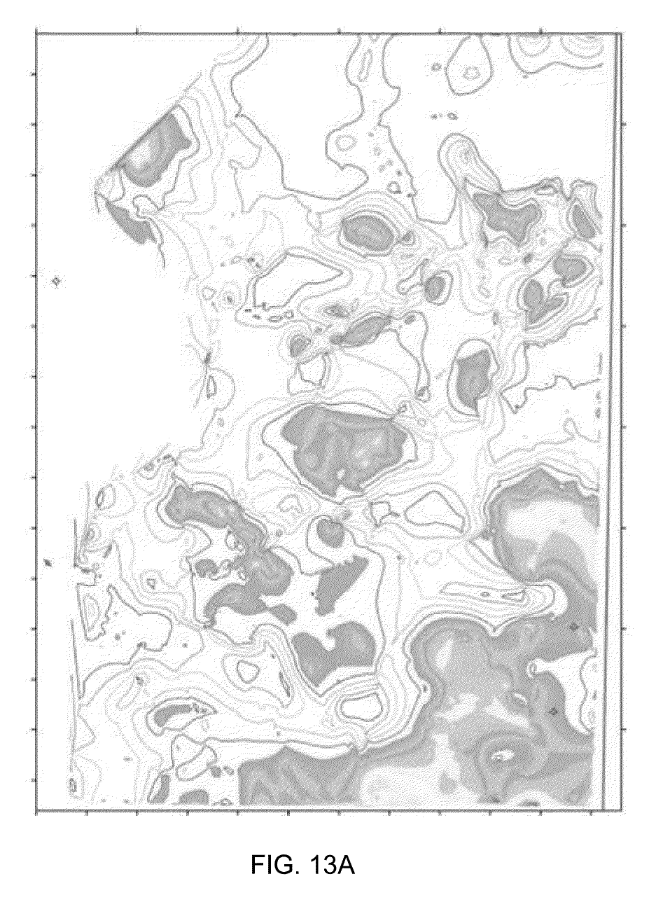

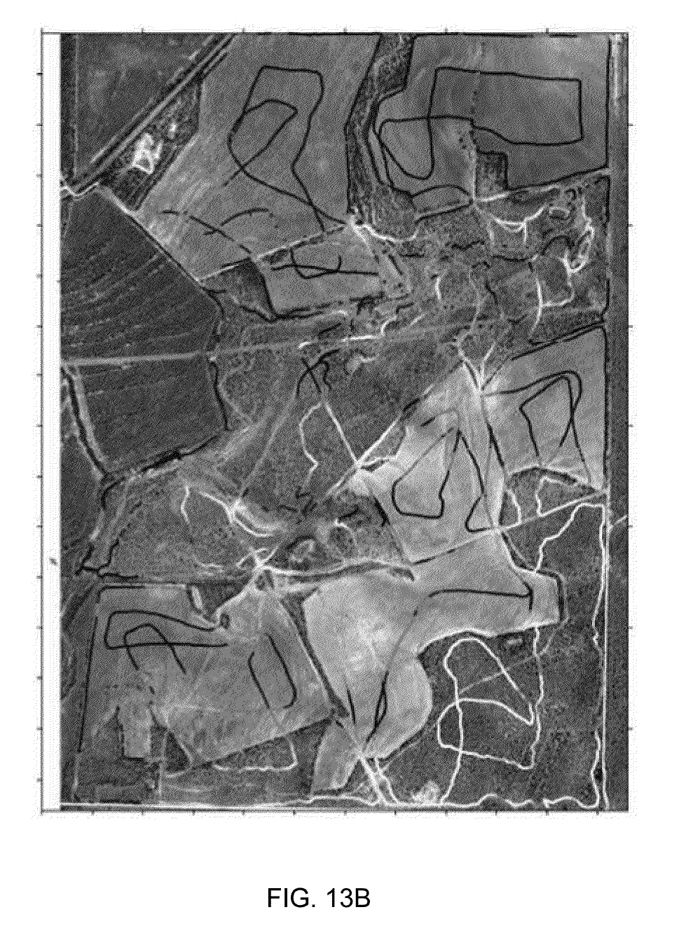

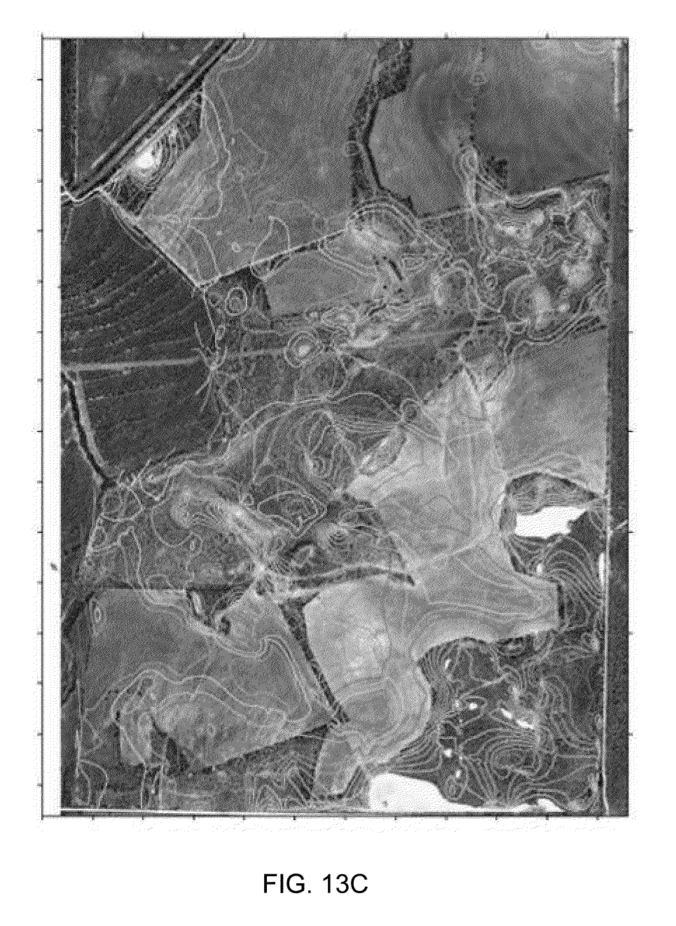

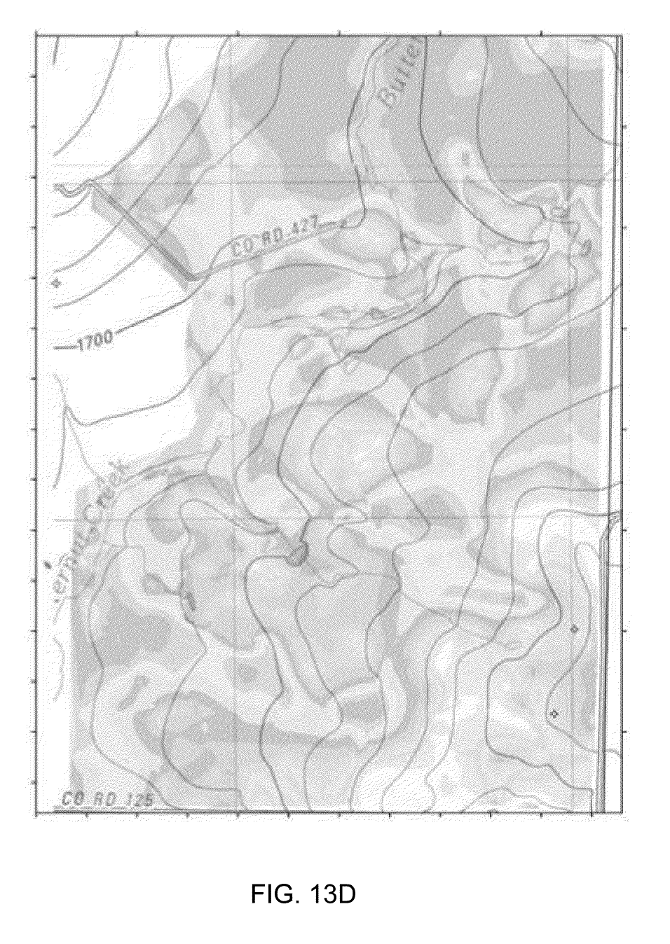

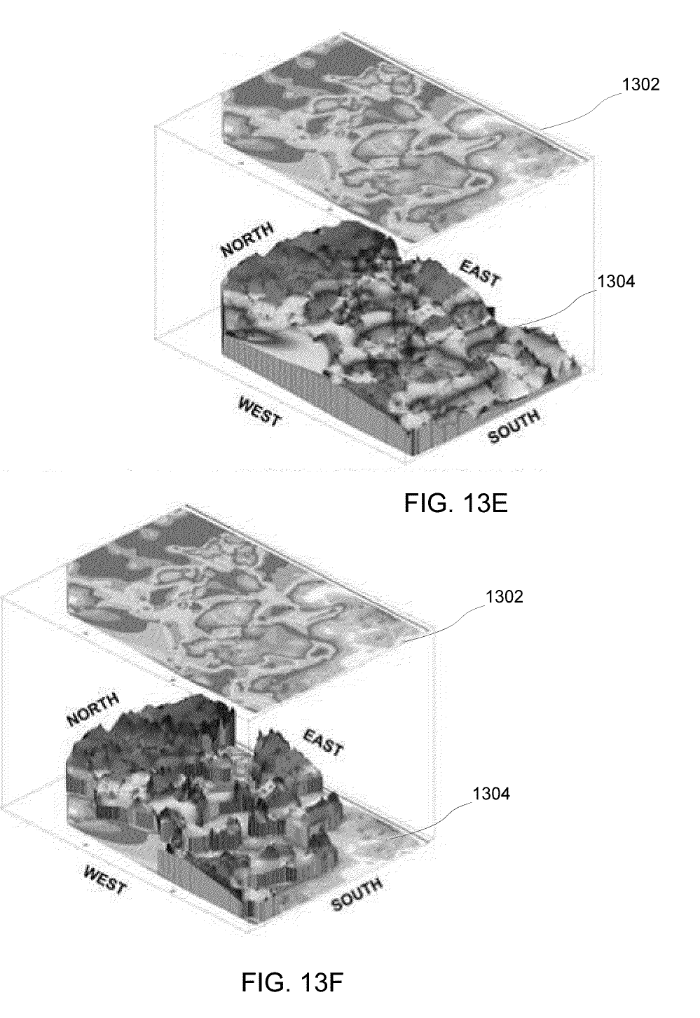

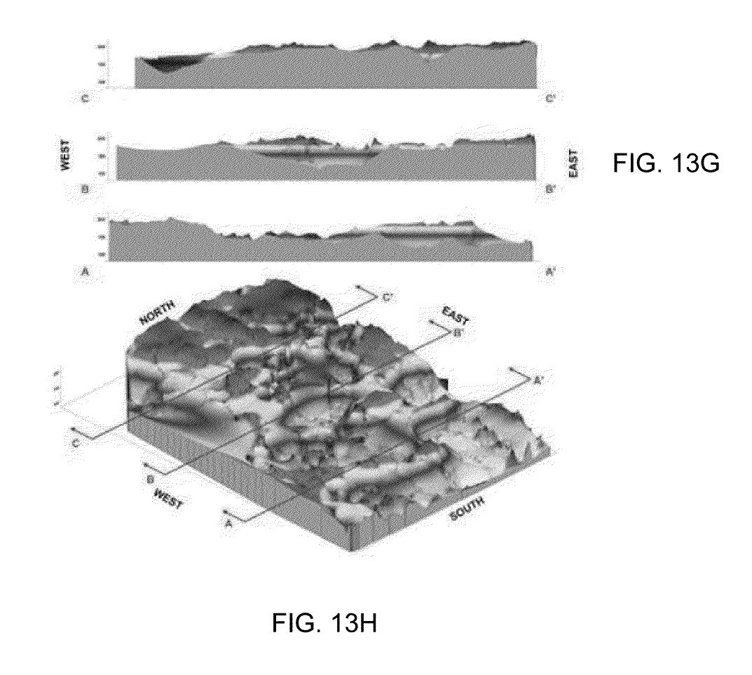

The system can also generate maps based on the radiation readings. These maps may be helpful in identifying areas where hydrocarbon deposits exist within the area of interest. Examples of such maps are shown in FIGS. 13A-13F.

During mapping, satellite images, topography maps, seismic maps, and the like may serve as base maps upon which contour maps and data may be overlaid. Satellite images, in an embodiment, can be obtained from public locations or services such as the Google Earth® software, for example. The mapping process may, in some cases, produce maps and other files that may be opened in Google Earth®. These satellite images may be useful in determining if a potential well location is accessible or not.

The recorded data may also be used to generate three dimensional projections of surface maps of the data. The three dimensional projection may include the contour map as well as other information. The Z values in such a map may represent the count per second readings and the model may have the same color scale as the contour maps and the classed post map.

A software application may be used to process the data to generate a grid of radiation readings. For example, a Contouring and 3D Surface Mapping for scientists and engineers may be used. The software may overlay, superimpose, conflate, or otherwise include radiation and location readings onto 3D surface maps, for example. A grid-based graphics program may interpolate irregularly spaced and/or scattered XYZ data onto a regularly spaced grid which may be used to generate contour maps. In one embodiment, the Z axis may be elevation, and the X and Y axes may be latitude and longitude or other projected coordinate system. The Z axis may also be used to represent a weight, reading, probability, or likelihood of the presence of radiation and/or hydrocarbon deposits. The various radiation counts may be superimposed upon a contour map in order to assist in detecting hydrocarbon deposits, for example.

FIGS. 13A-13H show examples of maps that can be generated by the present invention. FIG. 13A shows a contour map of the area of interest. The contours represent radiation readings taken from the traversal area shown in FIG. 13B. Shaded areas in FIG. 13A indicate locations where the radiation count was low, indicating a likelihood of the presence of hydrocarbons under the earth's surface. FIG. 13A may be the cornerstone of the imaging interpretation leading to the generation of all of the following maps, FIG. 13B-13H. In other words, the data taken from the initial traversal path may be used to generate the other maps produced by the system.

FIG. 13B and FIG. 13C are maps showing a satellite image overlay of the area of interest. FIG. 13B also overlays onto the map the traversal path traveled to take radiation readings from the area of interest. FIG. 13C overlays the contour of radiation readings onto the map. The satellite image overlays are beneficial to illustrate the traversal pattern in FIG. 13B, which can be used to verify that the correct and complete area was imaged by the field technicians. In addition, FIG. 13C allows the interpreter of the map to visualize potential drilling locations and any natural or man-made obstacles that may prevent a well location. In certain situations the satellite images may also be beneficial in determining if there is a relationship between radiation readings and particular vegetation in the imaged area.

FIG. 13D shows an overly of two contours: a geographic contour showing the topographic surface elevation of the area of interest and the radiation contour. Topography maps may be used to find correlations between the surface count per second readings and the terrain of the area. Changes in the surface terrain can be indicators of subsurface trapping mechanisms.

FIG. 13E and FIG. 13F show two examples of three-dimensional contour maps that can be generated by the system. In these maps, the two-dimensional contour 1302 can be projected onto a three-dimensional model 1304 that shows the contour of radiation readings in the area. Inversely, the three-dimensional model 1304 can be manipulated to illustrate specific changes in radiation counts per second projected over the contour 1302. The three-dimensional maps illustrated in FIG. 13E and FIG. 13F are beneficial for displaying the radiation count per second readings in a manner that simplifies the visual representation. In an embodiment, FIG. 13F is useful for displaying the potential closure mechanisms that justify the presence of hydrocarbon deposits by only displaying the higher count per second readings protruding from the two-dimensional contour 1302.

FIG. 13G shows cross sections of the three-dimensional contour map of FIG. 13H, that can be generated by the system. This cross sections illustrated in FIG. 13G can be orientated along any three-dimensional plane within the imaged area. These cross sectional analysis' can be generated along a path that connects multiple well locations. The cross section along the well path can then be used to show a relationship between the surface gamma ray radiations with subsurface gamma ray logs from the well bore holes. The gamma ray logs have to be provided or obtained by other means.

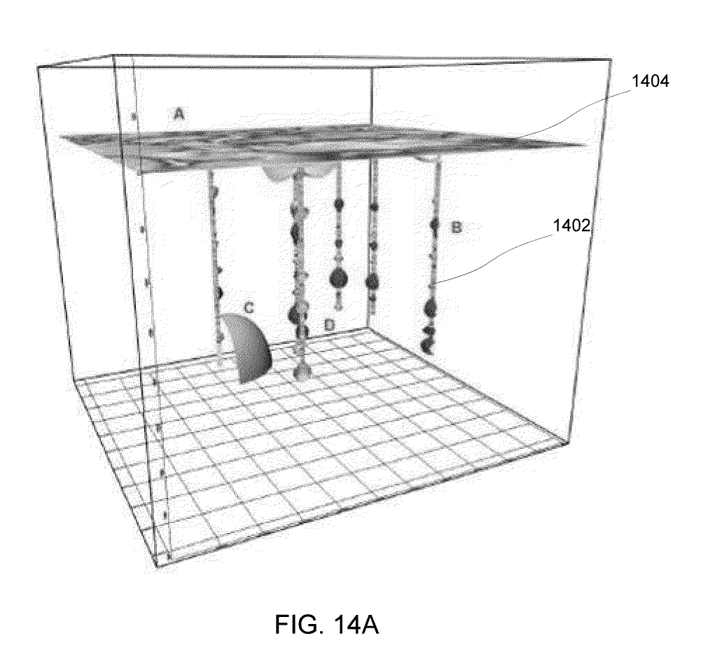

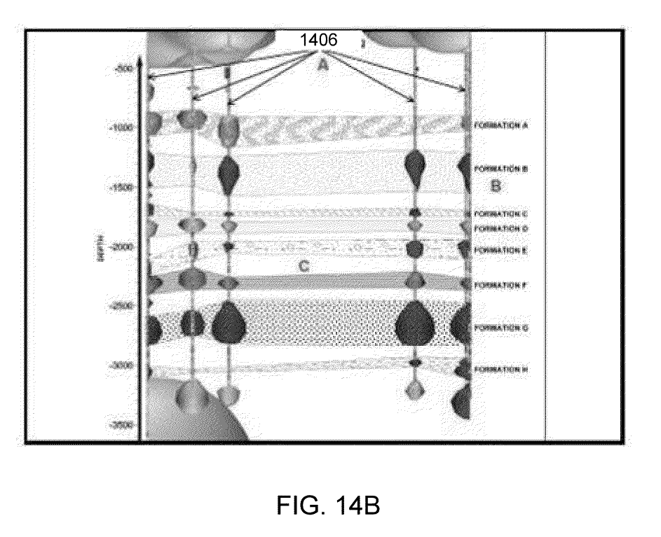

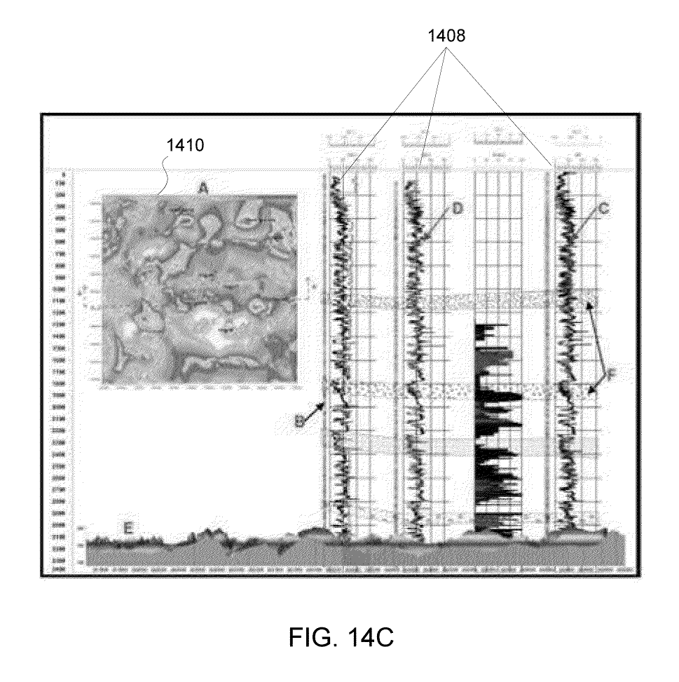

In another example, and as shown in FIG. 14A, the system can produce a subsurface, three-dimensional map showing subsurface gamma ray logs 1402 with potential hydrocarbon deposits. As shown in FIG. 14B, gamma ray logs 1406 can be incorporated into the mapping process. These logs 1406 show radiation measurements that have been taken below the surface, and provide a map of the layers of strata and subsurface formations. To obtain the logs 1406, a vertical hole is drilled, and a radiation sensor 10 is lowered into the hole. The recorded radiation is used to map the subsurface structures. These gamma logs 1406 can be obtained from various third-party sources, or recorded by the system or other means, for incorporation into maps provided by the system. For instance, FIG. 14A shows an example display that uses the gamma ray logs 1406 in conjunction with a surface contour map 1404. The three-dimensional model in FIG. 14A is used to illustrate the correlation between the surface radiation counts from contour map 1404 and the subsurface counts per second from the gamma ray logs 1402. The surface recorded values, when used in conjunction with the subsurface gamma ray values 1402, can be used to determine if a well was drilled deep enough, or if there is a commercial hydrocarbon reserve deeper. This may be accomplished by using reservoir estimates based on the area and thickness of the zones, along with porosity, permeability and water saturation.

FIG. 14C is two-dimensional version of the map in FIG. 14B. Similarly to gamma ray logs 1402 in FIG. 14B, gamma ray logs 1408 show radiation readings and stratum under the surface of the area shown in contour map 1410. In an embodiment, the gamma ray logs 1408 may be generated from readings taken from points on contour map 1410. Similarly to FIG. 14B, the map in 14C can be used to determine if a well was drilled deep enough, or if there is a commercial hydrocarbon reserve deeper. This may be accomplished by using reservoir estimates based on the area and thickness of the zones, along with porosity, permeability and water saturation.

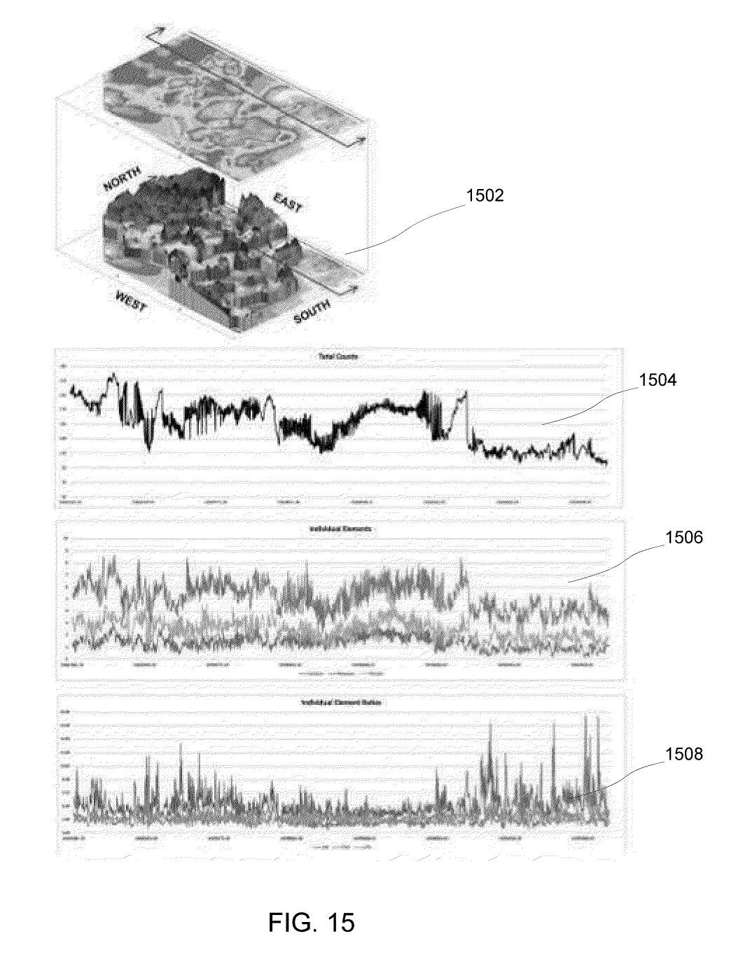

FIG. 15 provides another three-dimensional contour map 1502. The map 1502 also includes information about particular sources of the radiation. For example, graph 1504 shows the total radiation counts received, while graph 1506 show the radiation attributable to uranium, thorium, and potassium radiation sources. Graph 1508 may show the ratios between two of the individual element sources of radiation. The ratios represented in graph 1508 and individual element radiation values graph 1506 can assist in determining a relationship between a known hydrocarbon reservoir and a prospect in the same region. Separating the radiation into component sources allows for more accurate detection of hydrocarbon deposits. For example, by attributing detected radiation to an individual source, such as uranium, the system can determine whether radiation in the location is naturally high or naturally low, which can allow a more accurate detection of hydrocarbon deposits. If the radiation in and around an area is expected to be naturally high, but a low radiation reading is taken, it can indicate the presence of hydrocarbons within the area. The ratios depicted in graph 1508 are uranium divided by potassium, thorium divided by potassium and uranium divided by thorium. In this example as the total counts per second depicted in graph 1504 decrease toward the southern portion of the area of interest, the uranium divided by potassium ratio depicted in Graph 1508 increases, signaling a change in potassium and indicating a possible hydrocarbon marker.

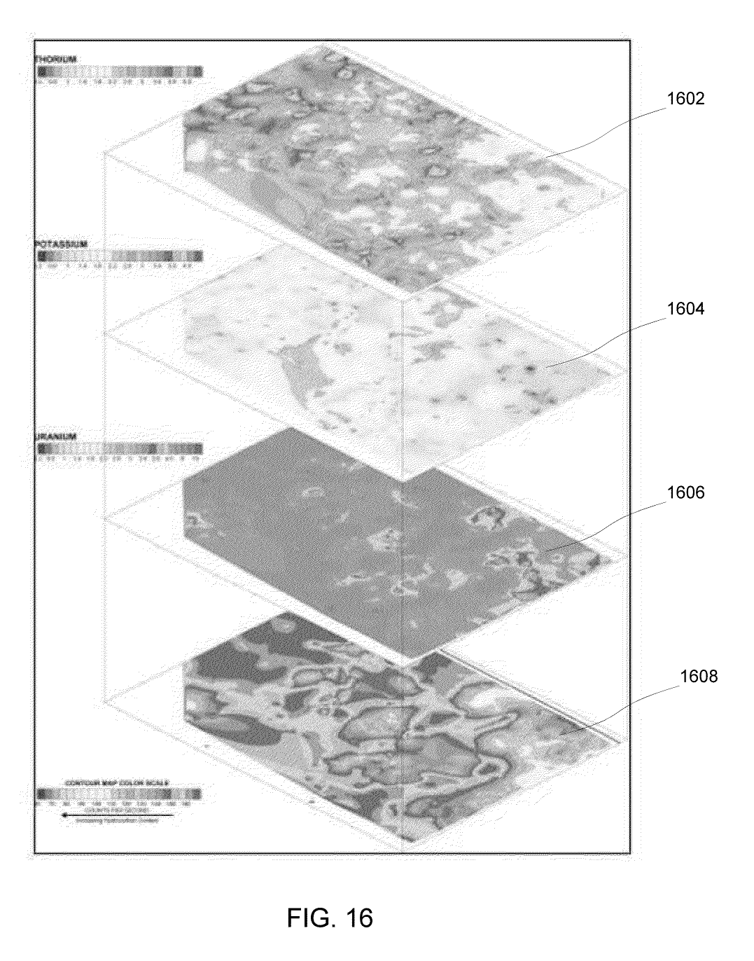

FIG. 16 illustrates a multi-contour map showing separation between radiation received from different sources. In FIG. 16, the contour map 1602 shows radiation attributable to thorium, contour map 1604 shows radiation attributable to potassium, contour map 1606 shows radiation attributable to uranium, and contour map 1608 shows the total amount of radiation received from the area of interest. Such contour maps can assist in locating and verifying hydrocarbon deposits by providing a visual representation of the radiation received and how the commonalities of the individual radiation elements may be affected by subsurface hydrocarbon deposits or the lack thereof.

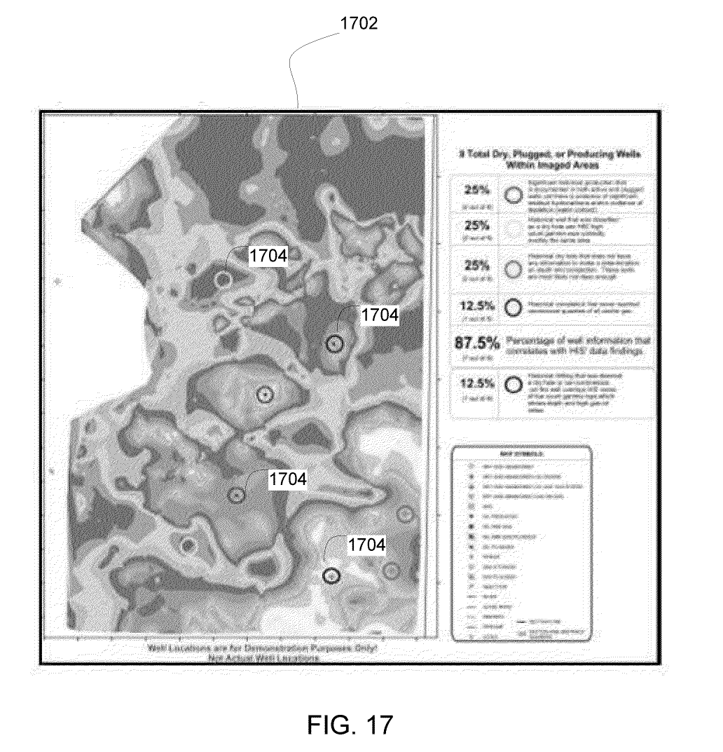

Historical well information, such as the location of producing or non-producing oil wells, can also be incorporated into the maps. Well information can provide additional information about oil deposits in the area and allow the system to determine whether its calculations are accurate. FIG. 17 shows a contour map 1702 produced by the system that includes known wells and their locations. For instance, wells 1703 and 1704 were deemed to be non-commercial wells, which correlate with high counts per second of radiation at the well locations, as illustrated on contour map 1702. Wells 1705, 1706, and 1707 are shown to be in a hydrocarbon rich area. Historically these wells were productive wells with significant reserves remaining. The medium to low gamma ray signatures verify this trend. Wells 1708 and 1709 were shallow non-commercial wells, but the gamma ray signatures indicate hydrocarbon deposits may be present at greater depths. Well 1710, was a non-commercial well that was drilled to a proper depth, but no consistent production was made. The gamma ray signature does not verify this trend and therefore may indicate a false positive. Despite the radiation reading and the likelihood of improper drilling or completion techniques, the historical well information incorporated into the contour map 1702 and showing that well 1710 did not produce, may indicate that the area is not suitable for commercial drilling. By correlating the areas where a high likelihood of hydrocarbon was computed with historical well information, the system can check the accuracy of its calculations and predictions for the presence of hydrocarbon deposits beneath the area of interest.

Various information about existing wells, which can be incorporated into the mapping/hydrocarbon detection process, may be obtained through public state agencies such as the Texas Railroad Commission or other public office. The data may also be obtained from paid services such as Drillmap, Drilling Info, and IHS. Data sources such as these may also provide information used in the mapping process such as the section lines, county lines, and roads, etc. The basic geology of the area may be acquired and taken into account in the mapping process. This information includes the porosity, formation thickness, the formations, oil saturation, etc., all of which may be incorporated into the hydrocarbon detection process.

In cases where an outside source (such as a customer or user of the process) has additional information that can be used, the information may be incorporated into the hydrocarbon detection process. Generally the system may obtain a plat map with the exact boundaries of the lease area so that during the imaging field work, they stay within the designated area. If the operator or the producer has information such as structure isopach maps or seismic maps, these may be used as base maps and overlay information.

Historical well information for the wells in and around the area of interest may be used to sort and plot the data to display the API number, well number, cumulative oil production, the cumulative gas production, etc. A table may be inserted into the map that displays all of the information along with the color for individual formations. Such a map, displaying formations of historical wells, is beneficial for relating the recorded surface counts per second with potential producing zones and the depths of individual formations. If the radiation counts per second are low enough, they justify a potentially deeper formation target.

The wells may, for example, be sorted by how much oil and gas they are producing or have produced. A circle with the corresponding color may be used to differentiate the area locations of the producing formations. These may be useful to determine possible trends of the gamma ray signatures and their alignment with trends of particular formations.

System

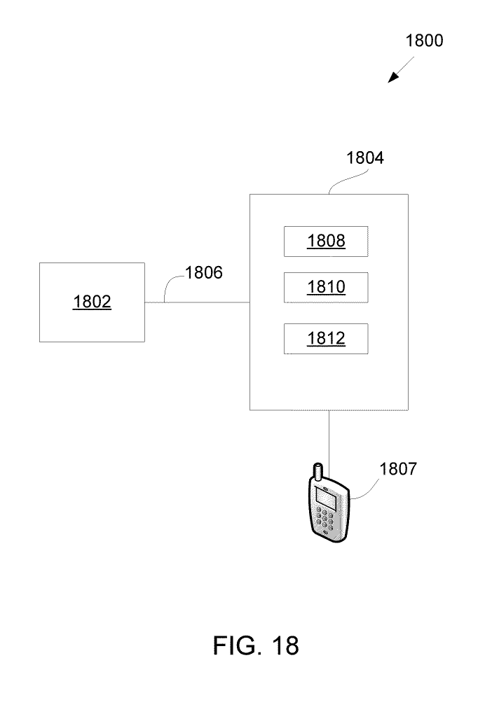

FIG. 18 shows a system 1800 for detecting hydrocarbon deposits in accordance with an embodiment of the invention. The system can include a sensor 10 as described above, including scintillators, housing, and circuitry for detecting radiation. The sensor 10 may be in communication with computing device 1804 through data cable 1806. Of course, sensor 10 may communication with computing device 1804 via any known data communication or network, including a wired network, a wireless network, a BlueTooth® network, a cellular network, etc. The system 1800 may also include a GPS receiver 1807 for determining the position of the system while the sensor 10 detects radiation within the area of interest.

In an embodiment, the system 1800 can include multiple computing devices which execute part or all of the software included within the system 1800. The computing devices can be local to one another, or located across one or more networks through which they can communicate.

Computing device 1804 may include a processor 1808, a memory 1810, and a non-volatile storage device 1812 (e.g. a hard drive). Memory 1810 and/or storage device 1812 may store software instructions, which, when executed by processor 1808, cause the computing system to perform operations that implement the invention. Such operations can include, but are not limited to: receiving radiation measurements from sensor 10, performing calculations relating to hydrocarbon detection, and producing maps and reports. Computing device 1804 may also include other components known in the computer arts including, but not limited to, a display screen, a keyboard, a mouse, an audio I/O, a USB port, etc.

Operation

In operation, a technician can use sensor 10 to detect hydrocarbon deposits under the earth's surface. Once an area of interest has been chosen, the technician can traverse the area while taking radiation readings with the sensor 10. The sensor 10 can be carried, mounted to a land vehicle or plane, or towed with a boat. During traversal, the sensor 10 may detect radiation readings emanating from the earth, which may be subsequently recorded by computing device 1804.

Once the area has been traversed, software on the computing device 1802 can perform calculations on the data received by sensor 10 to generate a baseline radiation level for the area. The calculations can take into account external factors such as geographical features under the surface of the area, historical well information, weather, the presence of radon or water, etc. The actual radiation readings can then be compared to the baseline in order to determine a difference between the readings and the baseline. Based on the difference, the software may determine whether the presence of hydrocarbons in the location is likely.

The software can also produce contour maps for visualizing hydrocarbon deposits within the area. In an embodiment, the maps can include a subsurface map showing the location, shape, and/or volume of likely hydrocarbon deposits.

The likely hydrocarbon deposits can then be evaluated for their commercial value prior to drilling a well to extract the deposits.

Having thus described the preferred embodiment of the invention it should be understood that numerous modifications and adaptations may be resorted to without departing from the scope of the invention, which is defined by the following claims.

What is claimed is:

1. A sensor for measuring radiation emanating from an earth surface, the sensor comprising:
a housing;
at least one scintillator, accommodated within the housing, structured to convert radiation emanating from an earth surface to a light pulse; and
a circuit, connected to the scintillator, to translate the light pulse into an electrical signal and to separate the electrical signal into component signals for data measurement and subsequent display.

2. A sensor as set forth in claim 1, wherein the housing includes a mechanism to minimize damage to the scintillator and circuit from physical shock.

3. A sensor as set forth in claim 1, wherein the housing is substantially fluid-tight to be used subaqueously.

4. A sensor as set forth in claim 3, wherein the housing includes a piston having a distal end for accessing an underwater surface to permit the scintillator to detect radiation emanating from the underwater surface.

5. A sensor as set forth in claim 1, wherein the housing includes a tubular structure within which the scintillator is accommodated and which can be towed along an underwater surface.

6. A sensor as set forth in claim 1, further comprising a positioning system that measures the position of the sensor so that the position can be associated with radiation measurements made by the sensor.

7. A sensor as set forth in claim 6, wherein the positioning system is a GPS.

8. A sensor as set forth in claim 6, wherein the positioning system is an underwater positioning system that can detect the location of the sensor in an underwater environment.

9. A sensor as set forth in claim 1, wherein the scintillator includes one of lutetium yttrium orthosilicate crystals, bismuth germinate crystals, sodium iodide crystals, cerium doped lanthanum bromide crystals, or a combination thereof.

10. A sensor as set forth in claim 1, wherein the circuit includes at least one programmable controller for separating the electrical signal into the component signals.

11. A sensor as set forth in claim 1, wherein the component signals include signals representative of radiation received from a particular radiation source, signals representative of total measured radiation, or a combination thereof.

12. A sensor as set forth in claim 11, wherein the radiation sources include one of Uranium, Thorium, Potassium, or a combination thereof.

13. A system for detecting hydrocarbon deposits, the system comprising:
a sensor that can measure radiation emanating from an earth surface within an area of interest and separate the measured radiation into component signals, each having a particular characteristic associated with a hydrocarbon signature; and
a computer process, stored within a computer readable medium, having instructions that cause a processor to:
receive the component signals from the sensor;
determine a difference between the component signals and a baseline radiation for the area of interest; and
display data showing a likelihood of the presence of hydrocarbon deposits in locations within the area of interest based on the difference between the measured radiation and the baseline radiation.

14. A system as set forth in claim 13, wherein the component signals include one of:
signals each representative of radiation received from a particular radiation source, signals representative of total measured radiation, or a combination thereof.

15. A system as set forth in claim 13, further comprising instructions that cause the processor to generate, from the measured radiation, one or more maps of the area of interest.

16. A method of determining whether hydrocarbon deposits are present, the method comprising:
establishing, by a computing system, a baseline amount of radiation expected to emanate from an area of interest;
adjusting, by the computing system, the baseline amount of radiation by incorporating into the baseline a predicted change in radiation due to interference factors that are present in the area;
measuring, by a radiation sensor, radiation emanating from the area of interest; and
determining, based on a difference between the baseline amount of radiation and the measured radiation, a likelihood that hydrocarbon deposits are present in the area.

17. A method as set forth in claim 16, wherein, in the step of adjusting, the interference factors include geographical features, roadway features, historical well information, subsurface water, weather information, or a combination thereof.

18. A method as set forth in claim 16, wherein, in the step of determining, the difference is caused by material beneath a surface of the area of interest that blocks the emanating radiation.

19. A method as set forth in claim 16, further comprising generating, from the measured radiation, a map of the area showing the likelihood that hydrocarbon deposits are present in the area.

20. A method as set forth in claim 19, wherein the map is a contour map with contours representing one of: the difference between the baseline amount of radiation and radiation measurements received from the sensor, the total measured radiation, component signals derived from the measured radiation, the likelihood that hydrocarbon deposits are present, or a combination thereof.

21. A method as set forth in claim 19, wherein the map includes subsurface strata information in particular locations on the contour map so as to providing correlations between known strata and the radiation measurements.

22. A method as set forth in claim 21, wherein the subsurface strata information includes gamma ray logs.

23. A method as set forth in claim 16, further comprising measuring the radiation while traversing the area of interest with a radiation sensor, so as to create a map of radiation measurements across the surface of the area.

24. A method as set forth in claim 16, further comprising associating a position with the radiation measurements so that the radiation measurements can be mapped.

25. A method as set forth in claim 16, further comprising extrapolating the radiation measurements onto locations within the area of interest where no radiation measurements were taken for inclusion in a map of radiation readings.

26. A method as set forth in claim 16, further comprising displaying a map that includes a visual representation of layers of substrate, based on the presence of gamma rays, beneath the area of interest for estimating the amount of hydrocarbon deposits present in the area of interest.
